(19) United States
(12) Patent Application Publication
(10) Pub. No.: US 2007/0103473 A1
(43) Pub. Date: May 10, 2007

(54) DISPLAY APPARATUS AND SIGNAL PROCESSING METHOD THEREOF

(75) Inventors: Joser Hu, Guei-Shan Hsiang, Taoyuan County (TW); Rick Liu, Guei-Shan Hsiang, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/381,388

(22) Filed: May 3, 2006

(30) Foreign Application Priority Data
Nov. 10, 2005 (TW) 094139440

(51) Int. Cl. G06F 15/16

(52) U.S. Cl. 345/503

(57) ABSTRACT

A display apparatus and a signal processing method thereof are disclosed. The display apparatus comprises a micro-controller, a detection module, an image processor, a first bus, and a second bus. The detection module is used to detect a status of the display apparatus. The image processor is used to process signals from the micro-controller. The first bus is used to electrically connect the image processor and the micro-controller. The second bus is used to electrically connect the micro-controller and the detection module. The detection module transmits the status of the display apparatus to the micro-controller via the second bus. The micro-controller communicates with the image processor via the first bus. Because of the micro-controller and the second bus, the workload of the image processor and the first bus is decreased.

### CROSS-REFERENCES TO RELATED APPLICATIONS

This application claims priority to Taiwan Patent Application No. 094139440 filed on Nov. 10, 2005.

### BACKGROUND OF THE INVENTION

1. Field of the Invention

The present invention relates to a display apparatus; in particular, relates to a display apparatus and a signal processing method using a micro-controller and two buses for sharing workloads of an image processor.

2. Descriptions of the Related Art

Excluding the requirements for image display quality of display apparatuses on the market, system stability is also important. Consequently, the display apparatuses pay much attention to the information of system peripheral environment, such as detections of an internal temperature, a voltage status. Take conventional front projectors for example, in addition to the high-definition in projection, a long-term normal operation is also considered. In particular, bulbs with high radiant heat are chosen as a light source in the front projector. Therefore, cooling problems are extremely important that a disaster may be caused with improper handling.

FIG. 1 illustrates a basic structure of an internal control interface of a conventional front projector. The front projector comprises an image decoder 1, a display module 2, an image processor 3, a bus 4 and an environmental monitoring module 5. The image processor 3 processes digital image signals, output from the image decoder 1, via the bus 4, and then transmits it to the display module 2 for displaying an image via the bus 4. The image processor 3 simultaneously communicates with the environmental monitoring module 5 via the bus 4 for monitoring the internal environment of the front projector. The environmental monitoring comprises temperature detection, fan rotation speed detection, voltage detection, and etc., to ensure that the front projector normally operates in a safe environment.

Generally, the image processor 3 sets up a plurality of independent procedures for executing the above-mentioned works synchronously. However, large amounts of data are required to be processed in the procedures and the same bus 4 is used to communicate with other devices. When a heavy workload occurs, the bus 4 could not transmit signals in real-time. Thus, the qualities of projection and environmental monitoring are affected. Furthermore, the bus 4 may turn paralyzed and have a direct effect upon the system stability.

According to the above descriptions, there exists a problem for current display apparatuses to be improved. In other words, it is an important topic that how to effectively share the workloads on the image processor and the transmitting interface thereof to ensure the operated system stable.

### SUMMARY OF THE INVENTION

The primary objective of the present invention is to provide a display apparatus comprising a micro-controller, a detection module, an image processor, a first bus and a second bus, wherein the detection module is used for detecting a status of the display apparatus, the image processor is used for processing signals transmitted from the micro-controller, the first bus is used for electrically connecting with the image processor and the micro-controller, and the second bus is used for electrically connecting with the micro-controller and the detection module.

Another objective of the invention is to provide a signal processing method which is prosecuted by the above-mentioned display apparatus. The method comprises the steps as follows:

(a) detecting the status of the display apparatus by the detection module and transmitting a signal to the micro-controller via the second bus;

(b) transmitting the signal to the image processor by the micro-controller via the first bus; and

(c) processing the signal in the image processor which is transmitted from the micro-controller.

Consequently, information of a status detected by the detection module of the present invention is transmitted to the micro-controller via the second bus. The micro-controller reports the status information back to the image processor via the first bus when necessary in order to decrease the workloads on the image processor and the first bus. The purpose of enhancing system stability could be achieved.

### BRIEF DESCRIPTION OF THE DRAWINGS

FIG. 1 is a diagram illustrating the front projector of the prior art; and

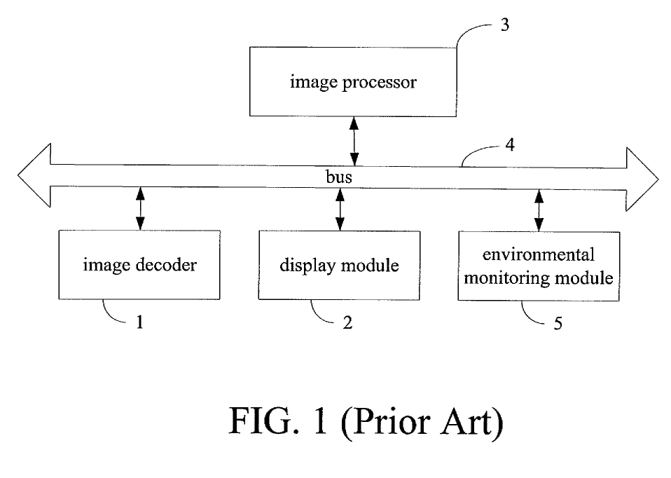

FIG. 2 is a diagram illustrating one embodiment of the present invention.

### DESCRIPTION OF THE PREFERRED EMBODIMENT

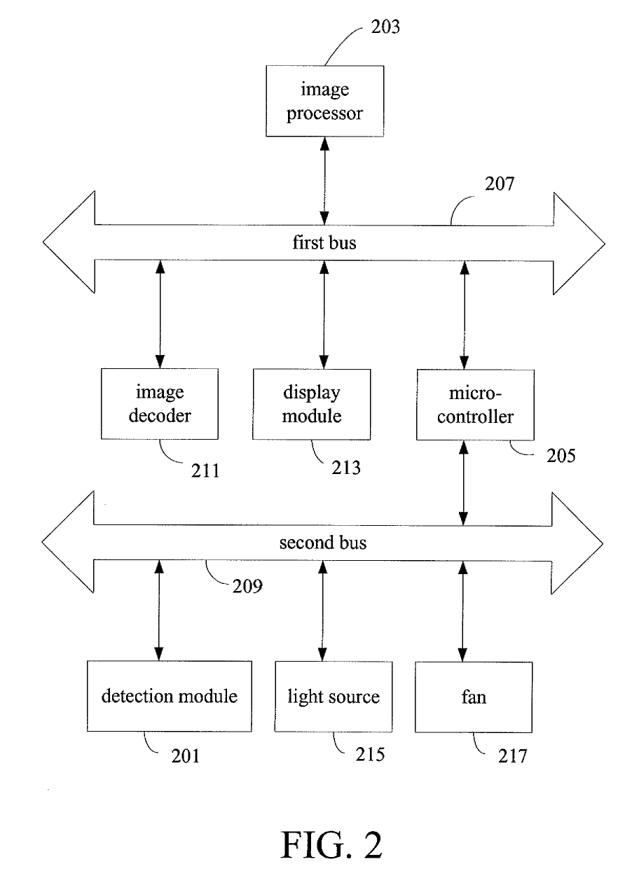

As show in FIG. 2, a preferred embodiment of a display apparatus of the present invention is a projector. The embodiment comprises a detection module 201, an image processor 203, a micro-controller 205, a first bus 207, a second bus 209, an image decoder 211, and a display module 213. The detection module 201 is used for detecting a status of the projector. The image processor 203 is the DDP2000 chip manufactured by the Texas Instruments, wherein the image processor processes the digital image signals, output from the image decoder 211, via the first bus 207, transmits the digital image signals to the display module 213 via the first bus 207 for displaying an image, and processes signals transmitted from the micro-controller 205 simultaneously. The micro-controller 205 is connected with the detection module 201 via the second bus 209. Consequently, information of a status detected by the detection module 201 is transmitted to the micro-controller 205 via the second bus 209. The first bus 207 and the second bus 209 are Inter-Integrated Circuit (I²C) buses.

The micro-controller 205 may comprise a universal asynchronous receiver/transmitter interface (UART interface) or a general purpose input/output interface (GPIO interface). Both can be an interface connected to the second bus 209 individually.

The micro-controller 205 operates in response to a computer program. The computer program comprises a primary recursive code and an interrupt service code, wherein the primary recursive code is used for controlling the micro-controller 205 to process the signals transmitted via the second bus 209, and the interrupt service code is used for requesting the micro-controller 205 to report the system status in response to the image processor 203 to control the micro-controller 205 interrupting the present executing tasks and to transmit report signals to the image processor 203 via the first bus 207.

As shown in FIG. 2, the projector further comprises a light source 215. The detection module 201 is used for detecting a temperature of the light source 215. An overheat protection switch (not shown in the figure) is adjacently disposed to the light source 215. When the detection module 201 detects that the light source 215 is overheated, the micro-controller 205 reports to the image processor 203 via the first bus 207. Then, the image processor 203 cuts off the overheat protection switch to avoid the projector from overheating. The detection module 201 is also used for detecting the brightness of the light source 215 for properly adjusting a supply voltage for the light source 215 to maintain the brightness of the light source 215.

As show in FIG. 2, the projector further comprises a fan 217. The detection module 201 can detect a rotation speed of the fan 217 or a supply voltage for the fan 217 for adjusting the rotation speed of the fan 217 and then adjust an internal temperature of the projector.

The detection module 201 can further detect an environmental temperature, environmental brightness, or environmental atmospheric pressure for adjusting the light source 215 or the fan 217 at any time according to the environmental variations. For example, a faster rotation speed of the fan is needed when the atmospheric pressure is lower, to achieve same effects on cooling.

The detection module 201 further comprises a tilt sensor for detecting a tilt angle of the projector. The display module 213 can appropriately adjust an angle of the projected image according to the detected tilt angle for maintaining the projected image in horizontal. This function enables the projector to be disposed on any desk other than a horizontal tabletop.

Another embodiment of the present invention is a signal processing method prosecuted by the above-mentioned display apparatus. The method comprises the steps as follows. First, the detection module 201 detects the status of the display apparatus and transmits a signal corresponding to the status to the micro-controller 205 via the second bus 209. Subsequently, the micro-controller 205 transmits the signal to the image processor 203 via the first bus 207. Then, the image processor 203 processes the signal after the signal is received.

More specifically, according to the signal processing method disclosed in the present invention, the micro-controller 205 performs the primary recursive code to process the signal transmitted via the second bus 209. When the image processor 203 requests the micro-controller reporting system statuses, the micro-controller 205 turns to perform the interrupt service code for interrupting the present executing tasks and processes the signal transmitted via the first bus 207.

Depending on the aforesaid method, the status could be corresponding to the temperature or brightness of the light source 205, the rotation speed or the supply voltage of the fan 205, the environmental temperature, the environmental brightness, the environmental atmospheric pressure, or the tilt angle of the display apparatus.

According to the above descriptions, the information of the status detected by the detection module 201 of the present invention is transmitted to the micro-controller 205 via the second bus 209. The image processor 203 processes the display of images via the first bus 207. The micro-controller 205 only reports the status information to the image processor 203 via the first bus 207 when necessary. Consequently, the present invention greatly decreases the workloads of the image processor 203 and the first bus 207 and achieves the purpose of enhancing the system stability.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display apparatus, comprising:
a micro-controller;
a detection module for detecting a status of the display apparatus;
an image processor for processing a signal transmitted from the micro-controller;
a first bus for electrically connecting the image processor and the micro-controller; and
a second bus for electrically connecting the micro-controller and the detection module.

2. The display apparatus as claimed in claim 1, wherein the micro-controller comprises a UART interface connected to the second bus.

3. The display apparatus as claimed in claim 1, wherein the micro-controller comprises a GPIO interface connected to the second bus.

4. The display apparatus as claimed in claim 1, wherein the micro-controller operates in response to a computer program, and the computer program comprises:
a primary recursive code for processing a signal transmitted via the second bus; and
an interrupt service code for processing a signal transmitted via the first bus.

5. The display apparatus as claimed in claim 1, wherein the first bus and the second bus are an Inter-Integrated Circuit (I²C) bus respectively.

6. The display apparatus as claimed in claim 1, further comprising a light source, wherein the status is a temperature of the light source.

7. The display apparatus as claimed in claim 1, further comprising a light source, wherein the status is a brightness of the light source.

8. The display apparatus as claimed in claim 1, further comprising a fan, wherein the status is a rotation speed of the fan.

9. The display apparatus as claimed in claim 1, further comprising a fan, wherein the status is a supply voltage of the fan.

10. The display apparatus as claimed in claim 1, wherein the status is an environmental temperature of the display apparatus.

11. The display apparatus as claimed in claim 1, wherein the status is an environmental brightness of the display apparatus.

12. The display apparatus as claimed in claim 1, wherein the status is an environmental atmospheric pressure of the display apparatus.

13. The display apparatus as claimed in claim 1, wherein the status is a tilt angle of the display apparatus.

14. A signal processing method prosecuted by a display apparatus, the display apparatus comprising a micro-controller, a detection module, an image processor, a first bus, and a second bus, the method comprising the following steps:
(a) detecting a status of the display apparatus by the detection module and transmitting a signal corresponding to the status to the micro-controller via the second bus;
(b) transmitting the signal to the image processor by the micro-controller via the first bus; and
(c) processing the signal transmitted from the micro-controller in the image processor.

15. The method as claimed in claim 14, further comprising a step after the step (b):
(d) performing a primary recursive code by the micro-controller for processing the signal transmitted via the second bus.

16. The method as claimed in claim 14, further comprising a step after the step (c):
(e) performing an interrupt service code by the micro-controller for processing the signal transmitted via the first bus.

17. The method as claimed in claim 14, wherein the status is corresponding to a temperature of a light source, a brightness of the light source, a rotation speed of a fan, a supply voltage of the fan, an environmental temperature, an environmental brightness, an environmental atmospheric pressure, or a tilt angle of the display apparatus.
